(19) United States
(12) Patent Application Publication
(10) Pub. No.: US 2022/0239660 A1
(43) Pub. Date: Jul. 28, 2022

(54) INFORMATION PROCESSING DEVICE AND NON-TRANSITORY COMPUTER READABLE MEDIUM

(71) Applicant: FUJIFILM BUSINESS INNOVATION CORP., Tokyo (JP)

(72) Inventor: Tsutomu SHIMAMOTO, Kanagawa (JP)

(73) Assignee: FUJIFILM BUSINESS INNOVATION CORP., Tokyo (JP)

(21) Appl. No.: 17/369,190

(22) Filed: Jul. 7, 2021

(30) Foreign Application Priority Data
Jan. 28, 2021 (JP) 2021-011939

(51) Int. Cl. H04L 29/06; G06F 21/32

(52) U.S. Cl. CPC H04L 63/104; H04L 63/0884; G06F 21/32; H04L 63/0861

(57) ABSTRACT

An information processing device includes: a processor configured to: when a first user performs an operation of joining a first group that is permitted to use a device or a service, cause an authentication server to perform a process of authentication with an authenticator, the process of the authentication using biometric authentication; and when the authentication of the first user performed by the authentication server is successful, cause a group management server that manages the first group to perform a process of adding the first user to the first group.

### CROSS-REFERENCE TO RELATED APPLICATIONS

This application is based on and claims priority under 35 USC 119 from Japanese Patent Application No. 2021-011939 filed Jan. 28, 2021.

### BACKGROUND

### (i) Technical Field

The present disclosure relates to an information processing device and a non-transitory computer readable medium.

### (ii) Related Art

JP-A-2018-205906 has an object to provide a mechanism that can control a device to which a service is provided while adopting a secure authentication mechanism when a network service is used with an image processing device. JP-A-2018-205906 discloses an image processing device that can communicate with a user's mobile terminal that includes an authentication module for biometric authentication. When receiving verification data issued by a service providing system, the image processing device uses the authentication module in the mobile terminal for the biometric authentication. The image processing device further requests a device authentication system linked with the service providing system to issue an authentication token.

### SUMMARY

In one case, when a user joins a group that is permitted a device or a service, an administrator performs an operation of adding the user. In this case, the administrator is to start the operation. Therefore, the user who wants to join needs to request the administrator. Aspects of non-limiting embodiments of the present disclosure relate to an information processing device and a non-transitory computer readable medium that, in adding a user to a group that is permitted to use a device or a service, can add the user to the group in response to the user who wants to join the group starting an operation.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing device including: a processor configured to: when a first user performs an operation of joining a first group that is permitted to use a device or a service, cause an authentication server to perform a process of authentication with an authenticator, the process of the authentication using biometric authentication; and when the authentication of the first user performed by the authentication server is successful, cause a group management server that manages the first group to perform a process of adding the first user to the first group.

### BRIEF DESCRIPTION OF THE DRAWINGS

Exemplary embodiment(s) of the present disclosure will be described in detail based on the following figures, wherein:

FIG. 1 is a conceptual module configuration diagram showing a configuration example according to an exemplary embodiment;

FIG. 2 is a diagram showing a configuration example of a system using the present exemplary embodiment;

FIG. 3 is a diagram showing an example of a prerequisite technology (FIDO authentication technology);

FIG. 4 is a flowchart showing a process example by the prerequisite technology (FIDO authentication technology);

FIG. 5A is a flowchart showing a process example according to the exemplary embodiment;

FIG. 5B is a flowchart showing a process example according to the exemplary embodiment;

FIG. 5C is a flowchart showing a process example according to the exemplary embodiment;

FIG. 6 is a diagram showing an example of a data structure of a group management table;

FIG. 7 is a diagram showing an example of a data structure of a user/device management table;

FIG. 8 is a diagram showing an example of a data structure of a group/device management table.

FIG. 9 is a diagram showing an example of a data structure of a group/user management table;

FIG. 10 is a flowchart showing a process example according to the exemplary embodiment; and

FIG. 11 is a flowchart showing a process example according to the exemplary embodiment.

### DETAILED DESCRIPTION

Hereinafter, an example of an exemplary embodiment for implementing the present disclosure will be described with reference to the accompanying drawings.

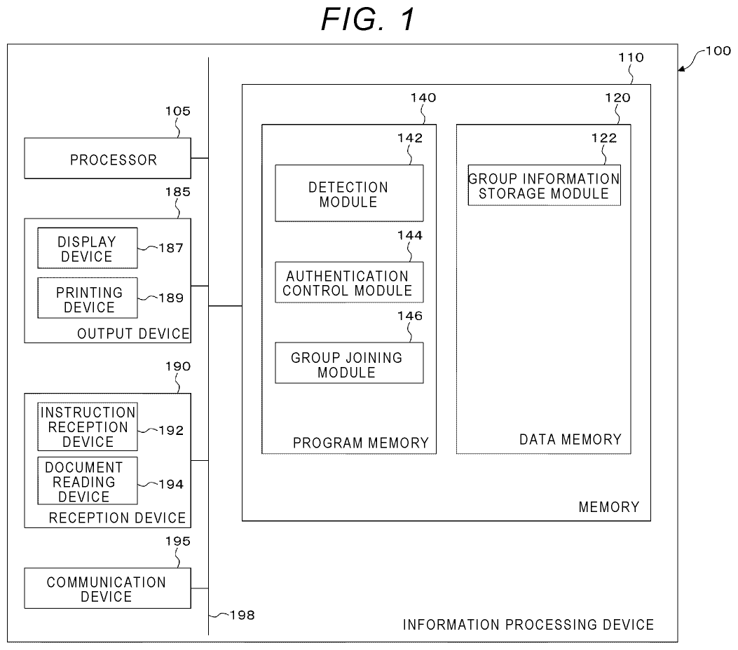

FIG. 1 is a conceptual module configuration diagram showing a configuration example of the present exemplary embodiment.

A term “module” generally refers to a component such as software (including a computer program as an interpretation of “software”) and hardware that are logically separable. The term “module” in the present exemplary embodiment refers to not only a module in the computer program but also a module in a hardware configuration. Therefore, the present exemplary embodiment also serves as a description of the computer program (for example, a program that causes a computer to execute each procedure, a program that cases a computer to function as each unit, and a program that causes a computer to implement each function), a system, and a method of implementing as those modules. For convenience of illustration, terms “store” and “stored”, and equivalent terms thereof are used. It is noted that these terms mean that when the exemplary embodiment is the computer program, the computer program is stored in a storage device or control is performed to store the computer program in the storage device. The module may have a one-to-one correspondence with the function. In implementation, one module may be implemented by one program, plural modules may be implemented by one program, or conversely, one module may be implemented by plural programs. The plural modules may be executed by one computer, or one module may be executed by plural computers in a distributed or parallel environment. One module may include another module. Hereinafter, a term “connection” is used not only for physical connection but also for logical connection (for example, data transfer, instruction, reference relationship between data, login, or the like). A term “predetermined” means that something is determined before a target process, and includes a meaning of being determined before the process according to the present exemplary embodiment starts, and a meaning of being determined in accordance with a situation and state at that time or in accordance with the situation and state up to that time even after the process according to the present exemplary embodiment has started but before the target process. When there are plural “predetermined values”, the values may be different values, or two or more values (“two or more values” include, of course, all values) may be the same. A description “if A, do B” is used to mean “determine whether it is A, and if it is determined to be A, do B”. It is noted that a case where it is not necessary to determine whether it is A is excluded. When things are listed such as “A, B, and C”, it is an example list unless otherwise specified, and includes a case where only one of the elements is selected (for example, only A).

A system or a device may be configured such that plural computers, hardware, devices, or the like are connected by a communication unit such as a network (including a one-to-one communication connection with a “network”), or may be implemented by one computer, hardware, a device, or the like. The terms “device” and “system” are used as synonyms. Of course, the “system” does not include anything that is nothing more than a social “mechanism” (that is, a social system) that is an artificial arrangement.

For each process by each module or for each process when plural processes are performed in a module, target information is read from a storage device, and after the processes are performed, process results are written in the storage device. Therefore, description of the reading from the storage device before the process and the writing into the storage device after the process may be omitted.

An information processing device 100 according to the present exemplary embodiment has a function of performing a process of adding a user to a group. As shown in an example of FIG. 1, the information processing device 100 includes at least a processor 105 and a memory 110. A bus 198 connects the processor 105 and the memory 110 for data exchange. The information processing device 100 may include an output device 185, a reception device 190, and a communication device 195. The data is exchanged among the processor 105, the memory 110, the output device 185, the reception device 190, and the communication device 195 via the bus 198.

A block diagram shown in the example of FIG. 1 also shows a hardware configuration example of a computer that implements the present exemplary embodiment. The hardware configuration of the computer on which the program according to the present exemplary embodiment runs is, for example, a computer shown in FIG. 1, and is specifically a personal computer, a computer or the like that can serve as a server. As a specific example, the processor 105 is used as a processing unit, and the memory 110 is used as the storage device.

There may be one processor 105 or plural processors 105. The processor 105 includes, for example, a central processing unit (CPU), a microprocessor, or the like. When the plural processors 105 are used, any form of a tightly coupled multiprocessor and a loosely coupled multiprocessor may be used. For example, plural processor cores may be mounted in the one processor 105. Further, a system may be used in which the plural computers are connected by a communication path to behave virtually like one computer. As the specific example, the loosely coupled multiprocessor may be configured as a cluster system or a computer cluster. The processor 105 executes a program in a program memory 140.

The memory 110 may include, for example, a semiconductor memory inside the processor 105 such as a register or a cache memory, be a main memory that is a main storage device configured with a random access memory (RAM), a read only memory (ROM), or the like, be an internal storage device such as a hard disk drive (HDD) or a solid state drive (SSD) having a function as a persistent storage device, an external storage device or an auxiliary storage device such as CD, DVD, a Blu-ray (registered trademark) Disc, a USB memory, or a memory card, or may include a storage device such as a server connected via a communication line.

The memory 110 includes a data memory 120 that mainly stores data and the program memory 140 that mainly stores the program. In addition to information shown in FIG. 1 and the program of a module, the data memory 120 and the program memory 140 may store a program such as an OS for starting the computer and data such as a parameter that changes appropriately during execution of the module.

The output device 185 includes, for example, a display device 187 and a printing device 189. Examples of the display device 187 include a liquid crystal display, an organic EL display, a three-dimensional display, and a projector. The display device 187 displays the process result by the processor 105, the data in the data memory 120, or the like as a text, image information, or the like. Examples of the printing device 189 include a printer and a multifunction device. The printing device 189 prints the process result by the processor 105, the data in the data memory 120, or the like. The output device 185 may include a speaker, an actuator that vibrates a device, or the like.

The reception device 190 includes, for example, an instruction reception device 192 and a document reading device 194. Examples of the instruction reception device 192 include a keyboard, a mouse, a microphone, and a camera (including a gaze detection camera). The instruction reception device 192 receives data based on an operation (including an action, a voice, a line of sight, or the like) of a user with respect to the device.

Further, there may be provided a device, such as a touch screen, having functions of both the display device 187 and the instruction reception device 192 In this case, in order to implement the function of the keyboard, even if there is no physical key, the keyboard (also called a software keyboard, a screen keyboard, or the like) may be drawn on the touch screen by software.

As a user interface, the display device 187 and the instruction reception device 192 are mainly used.

Examples of the document reading device 194 include a scanner and the camera. The document reading device 194 reads a document or captures an image of a document, and receives generated image data.

The communication device 195 is a communication line interface such as a network card that connects to another device via the communication line.

In an exemplary embodiment implemented by a computer program among the present exemplary embodiment, the computer program that is software is read into the program memory 140 of the present hardware configuration, and software and hardware resources cooperate to implement the present exemplary embodiment. That is, an information processing by the software uses the hardware resources (including at least the processor 105, the memory 110, and the output device 185, the reception device 190, and the communication device 195 in some cases) to specifically implement the present exemplary embodiment, and the law of nature is used as a whole.

The hardware configuration shown in FIG. 1 shows one configuration example. The present exemplary embodiment is not limited to the configuration shown in FIG. 1, but may be a configuration capable of executing the module described in the present exemplary embodiment. For example, as the processor 105, a graphics processing unit (GPU, including general-purpose computing on graphics processing units (GPGPU)) may be used. An execution of some modules may be configured with dedicated hardware, for example, an integrated circuit for a specific application (as a specific example, there is an application specific integrated circuit (ASIC), or the like) or a reconfigurable integrated circuit (as the specific example, there is a field-programmable gate array (FPGA), or the like). Some modules may be provided in an external system and connected by a communication line. Furthermore, plural systems each shown in FIG. 1 may be connected to each other by the communication line so as to cooperate with each other. In particular, in addition to the personal computer, the processor may be incorporated in a mobile information communication device (including a mobile phone, a smartphone, a mobile device, a wearable computer, or the like), an information home appliance, a robot, a copier, a fax, a scanner, a printer, the multifunction device (image processing device that has any two or more functions such as the scanner, the printer, the copier, the fax, or the like), or the like.

The processor 105 is connected to the memory 110, the output device 185, the reception device 190, and the communication device 195 via the bus 198. The processor 105 executes a process in accordance with the computer program describing an execution sequence of each of modules that are the program in the program memory 140. For example, in response to the instruction reception device 192 receiving a user's operation, a process by a module which corresponds to the operation and which is stored in the program memory 140 is executed, and the process result is stored in the data memory 120, output to the display device 187, or transmitted to another device by controlling the communication device 195.

The memory 110 includes the data memory 120 and the program memory 140. The memory 110 is connected to the processor 105, the output device 185, the reception device 190, and the communication device 195 via the bus 198.

The data memory 120 includes a group information storage module 122.

The group information storage module 122 stores information on a group. In order to manage a user belonging to the group as the information on the group, the group and the user are stored in association with each other. Further, in order to manage the information processing device 100 used by the user, the group, the user, and the information processing device 100 may be stored in association with each other. Data in the group information storage module 122 is acquired from a group management server 230. Conversely, when the data in the group information storage module 122 is updated, data in the group management server 230 is updated by transmitting the data to the group management server 230.

Further, the group information storage module 122 may store information that associates the information processing device 100 with the group as the information on the group. A correspondence between the information processing device 100 and the group is used in managing the information processing device 100 that can be used by the group.

The program memory 140 stores a detection module 142, an authentication control module 144, and a group joining module 146.

The detection module 142 detects if the user performs an operation of joining a group that is permitted to use a device or a service, on the instruction reception device 192. For example, a “Join Group X” button is displayed on the display device 187, and the detection module 142 detects if the button is selected.

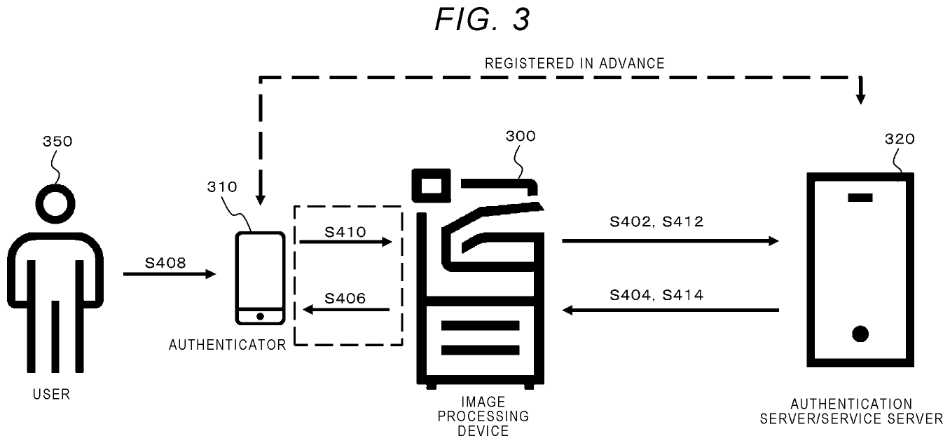

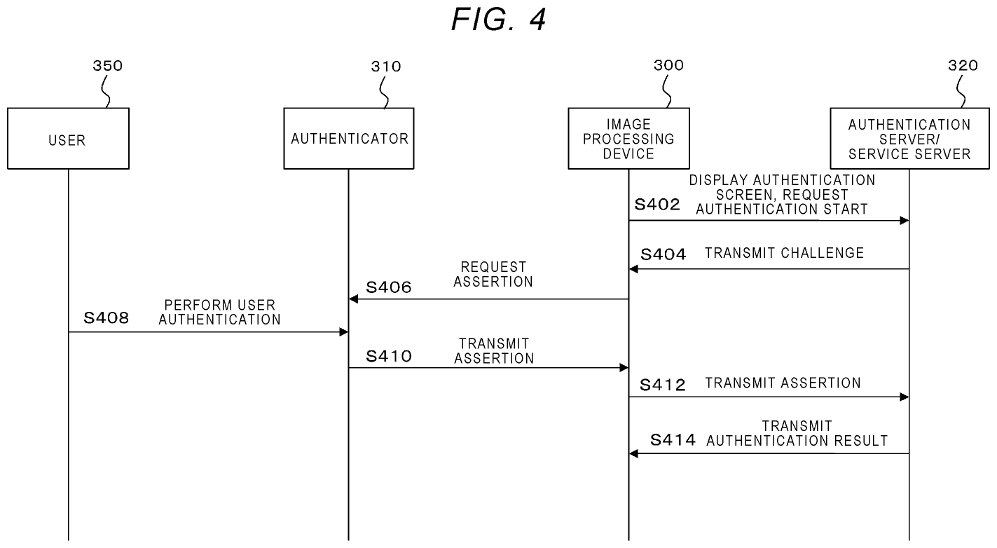

When the user performs the operation of joining the group which is permitted to use the device or the service, the authentication control module 144 causes an authentication server to perform a process of authentication with an authenticator. The process of authentication uses biometric authentication. That is, when the detection module 142 detects that the user performs the operation of joining the group, the authentication control module 144 causes the authentication server to perform the process of the authentication (which uses the biometric authentication) with the authenticator owned by the user. As the authentication, any technique may be used if it uses the biometric authentication. For example, FIDO authentication may be used. The “FIDO authentication” is one of authentication techniques and conforms to a standard established by FIDO Alliance. “FIDO” is an abbreviation for Fast IDentity Online. In a case of using the FIDO authentication, the information processing device 100 has a role of a FIDO client. The “FIDO client” is located between (i) an authentication server/service server 220 that is the authentication server and (ii) the authenticator when the authentication server/service server 220 and the authenticator are connected to each other. The “FIDO client” has a role of passing an authentication parameter from the authentication server/service server 220 to the authenticator, causing the authenticator to generate an assertion, and transmitting the assertion to the authentication server/service server 220. Details of a process performed by the FIDO client will be described later with reference to examples of FIGS. 3 and 4. Examples of biometric information here include a fingerprint, a vein, a face, a retina, an iris, and a vein pattern of a palm of the user.

When the authentication of the user performed by the authentication server is successful, the group joining module 146 causes the group management server that manages the group to perform a process of adding the user to the group.

Conditions to add the user to the group may further include a condition that the authenticator used by the user is a predetermined authenticator. The “predetermined authenticator” may be, for example, an authenticator used in a group to be joined.

Further, when the authentication performed by the authentication server is successful, the authentication control module 144 may cause the authentication server to perform the process of the authentication (which uses biometric authentication) with the authenticator, for a second user who has already joined the group. That is, authentication of another user (at least one person) after the user who attempts to join the group is authenticated is added to the conditions to join a group. The “another person” is a group member of the group to be joined, and here is the second user.

In this case, when the authentication of the second user performed by the authentication server is successful, the group joining module 146 may cause the group management server to perform the process of adding the user who wants to join the group to the group.

In particular, the group joining module 146 may cause the group management server to perform the process of adding the user who wants to join the group to the group, under a condition that the second user is a predetermined user.

Here, the “predetermined user (that is, the second user)” means a user who has a role of permitting a new user to join the group in addition to the user who is a member of the group which the new user attempts to join. Examples of the predetermined user include an administrator of the group, a leader of the group, and a supervisor of the new user (this supervisor is also a member of the group). Whether a user is the predetermined user may be determined using data in which the user and a role (for example, the administrator) of the user are associated with each other.

When the user performs the operation of joining a second group that is permitted to use the device or the service, the authentication control module 144 may cause the authentication server to perform the process of the authentication (which uses the biometric authentication) with the authenticator.

Further, when the authentication of the user performed by the authentication server fails, the authentication control module 144 may cause the authentication server to perform the process of the authentication (which uses the biometric authentication) with the authenticator, for a third user who has already joined the second group.

Next, when the authentication of the third user performed by the authentication server is successful, the group joining module 146 may cause the group management server to perform the process of adding the user to the second group.

Further, when a notification indicating that the user has already been registered in the authentication server is received here, it may be determined that the authentication of the user performed by the authentication server has failed.

In that case, the group joining module 146 may cause the group management server to perform the process of adding the user to the second group, under a condition that the third user is the predetermined user.

Here, the “predetermined user (that is, the third user)” means a user who has a role of permitting a new user to join the second group in addition to the user who is a member of the second group which the new user attempts to join. Examples of the predetermined user include an administrator of the second group, a leader of the second group, and the supervisor of the new user (this supervisor is also a member of the second group). Whether a user is the predetermined user may be determined using data in which the user and a role (for example, the administrator) of the user are associated with each other.

The process performed by the group joining module 146 may be a process in the information processing device 100 that the group to be joined is permitted to use. Specifically, the process may be a process of extracting groups that are permitted use the information processing device 100 using “information that associates the information processing device 100 with the group” in the group information storage module 122, presenting the groups to the user who is operating the information processing device 100, and adding the user to the group selected by the user.

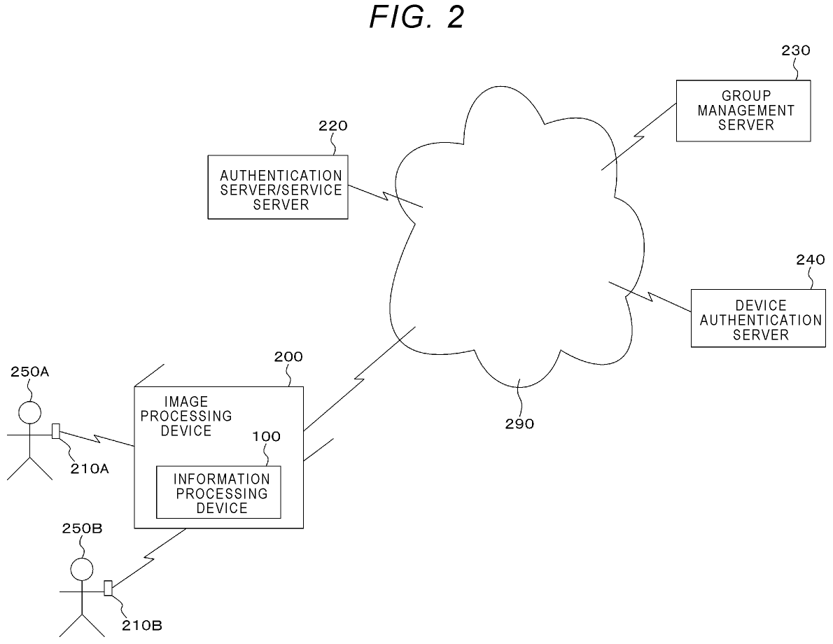

FIG. 2 is a diagram showing a configuration example of a system using the present exemplary embodiment.

An image processing device 200, the authentication server/service server 220, the group management server 230, and a device authentication server 240 are connected to each other via a communication line 290. The communication line 290 may be wireless, wired, or a combination thereof. The communication line 290 may be, for example, the Internet, an intranet, or the like as a communication infrastructure. Functions of the authentication server/service server 220, the group management server 230, and the device authentication server 240 may be implemented as a cloud service.

The image processing device 200 is an exemplary embodiment of the information processing device 100. Here, the image processing device 200 is a multifunction device that has a function of the information processing device 100 and the function of the FIDO client in the FIDO authentication.

The authentication server/service server 220 authenticates a user 250. For example, the server may be a relying party (RP) server in the FIDO authentication. Specifically, a FIDO server and a Web server are implemented, and a predetermined Web application is open to the public so that the user 250 can perform the FIDO authentication with the image processing device 200 and the authenticator 210.

The group management server 230 manages a group. The group management server 230 manages the group and a member of the group. For example, the group management server 230 is a human resource management server or the like of an organization.

The device authentication server 240 is a server that performs a device authentication using an authentication token in order to uniquely specify the image processing device 200 or the like registered in the device authentication server 240. The device authentication server 240 cooperates with the authentication server/service server 220 in order to guarantee the appropriate image processing device 200 to the authentication server/service server 220.

The authenticator 210 is a device that biometrically authenticates the user 250. Examples of the authenticator 210 include a smartphone and a wearable computer which are mobile terminals.

A user 250A has an authenticator 210A. The image processing device 200 and the authenticator 210A are connected to each other via the communication line.

A user 250B has an authenticator 210B. The image processing device 200 and the authenticator 210B are connected to each other via the communication line.

The user 250A is not a member of a group X and is attempting to join a group X. The user 250B is a member of the group X.

The user 250A performs an operation to add the user 250A to the group X. That is, a start point of joining the group X is an operation by the user 250A him/herself, but an operation by an administrator of the group X is not needed. Then, a biometric authentication of the user 250A is performed with the authenticator 210A. A result of the biometric authentication is transmitted to the authentication server/service server 220. If the authentication of the user 250A in the authentication server/service server 220 is successful, the user 250A is added to the group X using the group management server 230. As a matter of course, if the authentication of the user 250A in the authentication server/service server 220 fails, the user 250A is not added to the group X.

Further, conditions to add the user 250A to the group X may include a condition that the authentication of the user 250B who is the member of the group X is successful in addition to the condition that the authentication of the user 250A is successful. Specifically, after the user 250A is authenticated, the authentication of the user 250B is required. A biometric authentication of the user 250B is performed with the authenticator 210B. A result of the biometric authentication is transmitted to the authentication server/service server 220. If the authentication of the user 250B in the authentication server/service server 220 is successful, the user 250A is added to the group X using the group management server 230. As the matter of course, if the authentication of the user 250B in the authentication server/service server 220 fails, the user 250A is not added to the group X.

Furthermore, when the user 250A attempts to join another group Y after joining the group X, the same process may be performed. That is, a start point of joining the group Y is an operation by the user 250A him/herself, but an operation by an administrator of the group Y is not needed.

In this case, the user 250A has already joined the group X. The user 250A has been already registered in the authentication server/service server 220. Therefore, when a notification indicating that the user 250A has already been registered from the authentication server/service server 220, authentication of a member of the group Y may be required.

With reference to FIGS. 3 and 4, the FIDO authentication technology used in the present exemplary embodiment will be described.

FIG. 3 is a diagram illustrating an example of a prerequisite technology (FIDO authentication technology). FIG. 4 is a flowchart of a process example by the prerequisite technology (FIDO authentication technology).

An image processing device 300 mediates between an authenticator 310 and an authentication server/service server 320, and the FIDO authentication is performed between the authenticator 310 and the authentication server/service server 320.

The authenticator 310 and the image processing device 300 are connected to each other by, for example, USB, Bluetooth Low Energy (BLE), Near Field Communication (NFC), or the like.

In step S402, the image processing device 300 displays an authentication screen to a user 350, and requests the authentication server/service server 320 to start the authentication.

In step S404, the authentication server/service server 320 transmits a challenge in the FIDO authentication to the image processing device 300. The challenge is a random character string (including a pseudo random number) generated by the authentication server/service server 320.

In step S406, the image processing device 300 requests the authenticator 310 to make the assertion in the FIDO authentication. The assertion is a certificate of a verification result, and is specifically a signed challenge.

In step S408, the user 350 performs a user authentication with the authenticator 310. The user authentication uses biometric information. Examples of the biometric information include a fingerprint, a face, a retina, an iris, a vein pattern of a palm, or the like of the user 350.

In step S410, the authenticator 310 transmits the assertion in the FIDO authentication to the image processing device 300.

In step S412, the image processing device 300 transmits the assertion received in step S410 to the authentication server/service server 320.

In step S414, the authentication server/service server 320 performs the authentication using the challenge transmitted in step S404 and the assertion received in step S412, and transmits an authentication result to the image processing device 300.

As an authentication system including the biometric authentication, there is the FIDO authentication technology.

If the biometric information such as the fingerprint or the vein used in the biometric authentication is leaked to the outside, the biometric information cannot be rewritten unlike a password in an authentication using an ID and the password. Thus, leakage of the biometric information may be fatal.

To the contrary, in the FIDO authentication technology, an authentication operation using the biometric information is not performed on the server via the communication line such as the Internet, but is performed on the authenticator at hand of the user. Therefore, it can be said that the biometric information does not flow on the communication line, and there is less risk to leak the biometric information. The server via the communication line performs the authentication by a challenge-response method using a result of the authentication operation performed by the authenticator.

In a special authentication mechanism in which there is a low possibility that the biometric information flows on the communication line, the biometric information is strictly managed in a secure region in the authenticator that performs the authentication.

A system of the related art provides a service to a user on a device that can use a network service after performing an authentication in order to ensure security in an office or a public place.

It is assumed that a special authentication mechanism such as the FIDO authentication technology is applied to an authentication in a system including an image processing device that is installed in order to provide a network service to a user.

In such a mechanism, the specification allows the user to receive a service from any image processing device installed at any place, when the authentication is successful.

For example, when data output by the provided service is confidential or the like, it may be desired to limit the image processing device that provides the service according to conditions such as an installation location and a device performance. To this end, the group management server may be provided with a management table that manages a user ID and a group ID, and a management table that manages the group ID and a device ID in advance, so that it is possible to limit a device that the user can use.

However, when such a technique is used in a workplace where many users come and go, an administrator frequently updates the management tables and needs to add a user each time, which takes time and effort for the administrator.

In the present exemplary embodiment, a user is automatically added to the management table.

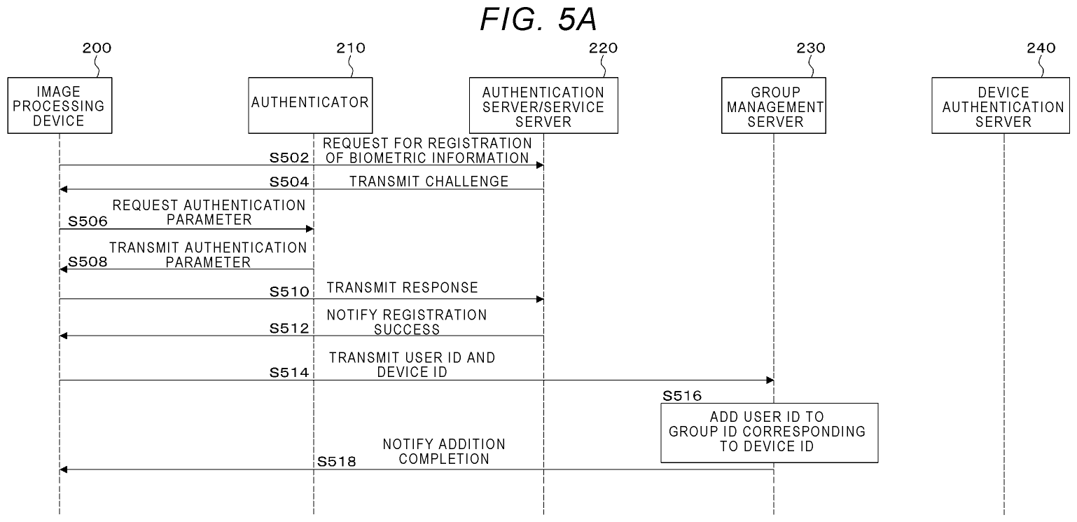

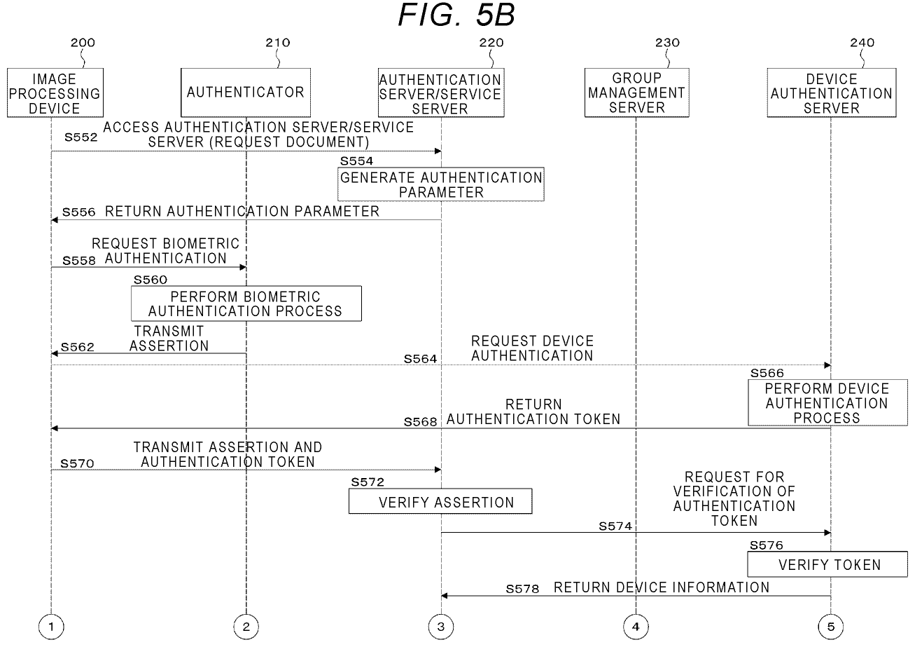

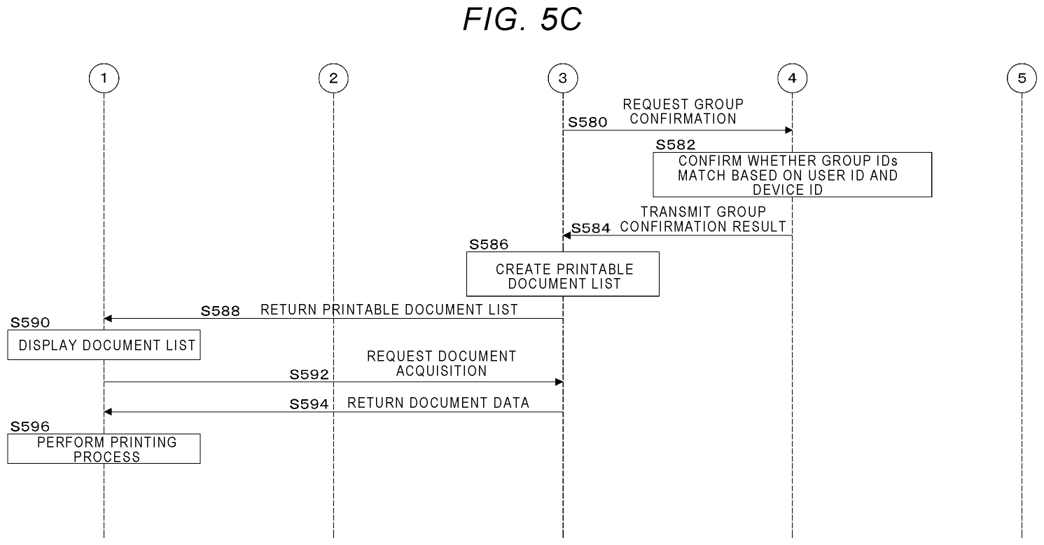

FIGS. 5A to 5C are flowcharts of a process example according to the present exemplary embodiment.

A registration procedure is performed from the authenticator 210 to the authentication server/service server 220 via the image processing device 200, so that a user ID and a device ID can be transmitted to the authentication server/service server 220. The user ID is information that uniquely specifies the user in the present exemplary embodiment. The device ID is information that uniquely specifies the image processing device 200 in the present exemplary embodiment.

The authentication server/service server 220 transmits the received user ID and the received device ID to the group management server 230.

The authentication server/service server 220 specifies a group ID based on the received device ID, and associates the group ID with the user ID.

It is assumed that the user ID has already been registered in the authentication server/service server 220. In addition, an example in which a printing service is performed as a network service will be described. As the matter of course, at present (at least in step S502), the user 250 does not belong to any group.

Steps S502 to S518 are a sequence of registering the user 250 in a group.

In step S502, the image processing device 200 requests the authentication server/service server 220 to register biometric information. Specifically, the user 250 has the authenticator 210 and starts a process of registering the biometric information from the image processing device 200. The image processing device 200 transmits a request for registration of the biometric information together with a user ID to the authentication server/service server 220.

In step S504, the authentication server/service server 220 transmits a challenge to the image processing device 200. Here, the challenge is a random character string (including the pseudo random number) generated by the authentication server/service server 220.

In step S506, the image processing device 200 transmits a request for an authentication parameter together with the challenge received in step S504 to the authenticator 210. Here, the authentication parameter is also referred to as an assertion, and is a certificate of a verification result. Specifically, the authentication parameter is a signed challenge.

In step S508, the authenticator 210 transmits the authentication parameter to the image processing device 200. Specifically, the authenticator 210 performs a biometric authentication of the user 250. When the authentication is successful, the authenticator 210 creates and transmits the authentication parameter to the image processing device 200.

In step S510, the image processing device 200 transmits a response to the authentication server/service server 220 together with the authentication parameter.

In step S512, the authentication server/service server 220 notifies the image processing device 200 of a registration success. Specifically, the authentication server/service server 220 stores the authentication parameter received in step S510 in association with the user ID, and transmits a registration success notification to the image processing device 200.

In step S514, the image processing device 200 transmits the user ID and the device ID to the group management server 230. The image processing device 200 that has received the registration success notification transmits a user/group association request to the group management server 230 together with the user ID and the device ID assigned to each image processing device 200.

In step S516, the group management server 230 adds the user ID to a group ID corresponding to the device ID. Specifically, the group management server 230 extracts the group ID associated with the device ID received in step S514, and associates the group ID with the user ID received in step S514.

In step S518, the group management server 230 notifies the image processing device 200 of an addition completion.

Steps S552 to S596 are a sequence of authenticating the user 250. That is, this is a method of limiting the image processing device 200 that the user is permitted to use, using the authentication parameter registered in the procedure from step S502 to step S518 and association information between the user ID and the group ID.

In step S552, the image processing device 200 accesses the authentication server/service server 220 to request a document.

In step S554, the authentication server/service server 220 generates an authentication parameter.

In step S556, the authentication server/service server 220 returns the authentication parameter to the image processing device 200.

In step S558, the image processing device 200 requests the authenticator 210 to perform the biometric authentication.

In step S560, the authenticator 210 performs a biometric authentication process.

In step S562, the authenticator 210 transmits an assertion to the image processing device 200.

In step S564, the image processing device 200 requests the device authentication server 240 to perform a device authentication.

In step S566, the device authentication server 240 performs a device authentication process.

In step S568, the device authentication server 240 returns an authentication token to the image processing device 200.

In step S570, the image processing device 200 transmits a combination of the assertion and the authentication token to the authentication server/service server 220.

In step S572, the authentication server/service server 220 verifies the assertion.

In step S574, the authentication server/service server 220 requests the device authentication server 240 to verify the authentication token.

In step S576, the device authentication server 240 verifies the token.

In step S578, the device authentication server 240 returns device information to the authentication server/service server 220.

In step S580, the authentication server/service server 220 requests the group management server 230 to confirm a group.

In step S582, the group management server 230 confirms whether group IDs match based on the user ID and the device ID.

In step S584, the group management server 230 transmits a group confirmation result to the authentication server/service server 220.

In step S586, the authentication server/service server 220 creates a printable document list.

In step S588, the authentication server/service server 220 returns the printable document list to the image processing device 200.

In step S590, the image processing device 200 displays the document list.

In step S592, the image processing device 200 requests the authentication server/service server 220 to acquire a document.

In step S594, the authentication server/service server 220 returns document data to the image processing device 200.

In step S596, the image processing device 200 performs a printing process.

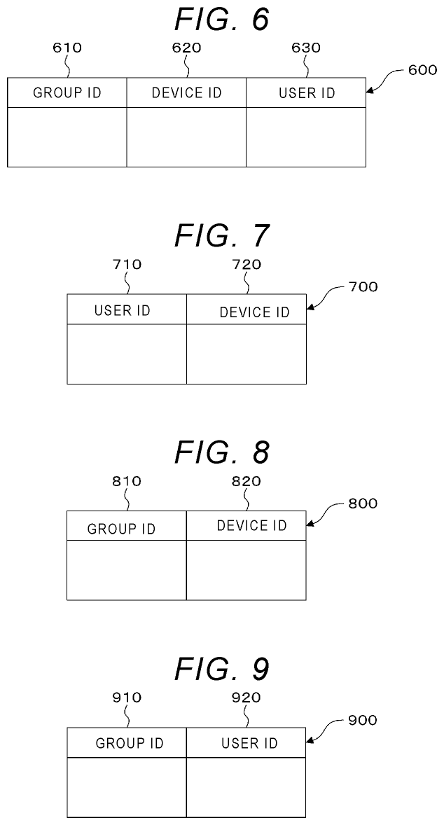

FIG. 6 is a diagram illustrating an example of a data structure of a group management table 600.

The group management table 600 includes a group ID column 610, a device ID column 620, and a user ID column 630. The group ID column 610 stores information (specifically, the group identification (ID)) for uniquely identifying a group in the present exemplary embodiment. The device ID column 620 stores information (specifically, the device ID) for uniquely identifying the image processing device 200 (or the information processing device 100) in the present exemplary embodiment. In the present exemplary embodiment, the user ID column 630 stores information (specifically, the user ID) for uniquely identifying a user.

The user of the group and the image processing device 200 that the group (or the user of the group) is permitted to use are managed based on the group management table 600.

Instead of the group management table 600, a user/device management table 700, a group/device management table 800, and a group/user management table 900 may be used.

FIG. 7 is a diagram illustrating an example of a data structure of the user/device management table 700.

The user/device management table 700 includes a user ID column 710 and a device ID column 720. The user ID column 710 stores the user ID. The device ID column 720 stores the device ID.

The image processing device 200 that the user is permitted to use is managed based on the user/device management table 700.

FIG. 8 is a diagram illustrating an example of a data structure of the group/device management table 800.

The group/device management table 800 includes a group ID column 810 and a device ID column 820. The group ID column 810 stores the group ID. The device ID column 820 stores the device ID.

The image processing device 200 that the group is permitted to use is managed based on the group/device management table 800.

FIG. 9 is a diagram illustrating an example of a data structure of the group/user management table 900.

The group/user management table 900 includes a group ID column 910 and a user ID column 920. The group ID column 910 stores the group ID. The user ID column 920 stores the user ID.

The user of the group is managed based on the group/user management table 900.

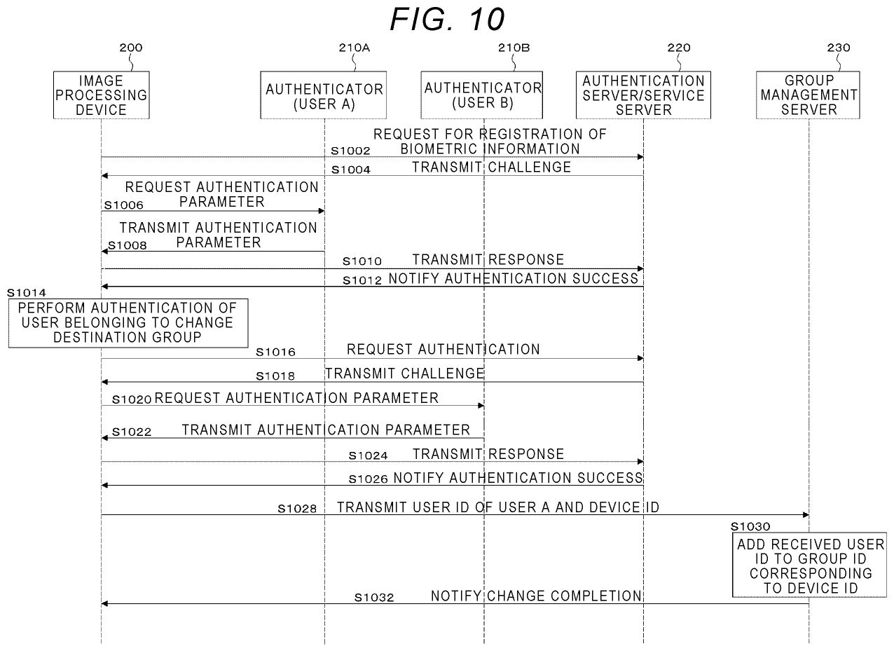

Instead of the processes from step S502 to step S518 illustrated in the example of FIG. 5A, a flowchart illustrated in an example of FIG. 10 may be used.

FIG. 10 is a flowchart of a process example according to the present exemplary embodiment. In this flowchart, in adding the user 250A to a group, the authentication of the user 250B who has already joined the group is required. Processes from step S1002 to step S1012 are equivalent to those from step S502 to step S512 shown in the example of FIG. 5. The user 250A who wants to join the group has the authenticator 210A. The user 250B who has already joined the group has the authenticator 210B. The user 250A is in the vicinity of the image processing device 200 together with the user 250B. As the matter of course, at present (at least in step S1002), the user 250A does not belong to the group that the user 250B has joined.

In step S1002, the image processing device 200 requests the authentication server/service server 220 to register biometric information.

In step S1004, the authentication server/service server 220 transmits a challenge to the image processing device 200.

In step S1006, the image processing device 200 requests the authenticator 210A for an authentication parameter.

In step S1008, the authenticator 210A transmits the authentication parameter to the image processing device 200.

In step S1010, the image processing device 200 transmits a response to the authentication server/service server 220.

In step S1012, the authentication server/service server 220 notifies the image processing device 200 of a successful authentication.

After step S1014, the image processing device 200 performs an authentication of the user 250B who belongs to the target group.

Processes from step S1016 to step S1026 are equivalent to those from step S1002 to step S1012, and a user to be authenticated is not the user 250A but the user 250B who has already joined the group.

In step S1016, the image processing device 200 requests the authentication server/service server 220 to perform an authentication.

In step S1018, the authentication server/service server 220 transmits a challenge to the image processing device 200.

In step S1020, the image processing device 200 requests the authenticator 210B for an authentication parameter.

In step S1022, the authenticator 210B transmits the authentication parameter to the image processing device 200.

In step S1024, the image processing device 200 transmits a response to the authentication server/service server 220.

In step S1026, the authentication server/service server 220 notifies the image processing device 200 of a successful authentication.

In step S1028, the image processing device 200 transmits a user ID of the user 250A and a device ID to the group management server 230 under a condition that the authentication of the user 250B is successful in step S1026. Processes from step S1028 to step S1032 are equivalent to those from step S514 to step S518 shown in the example of FIG. 5.

In step S1030, the group management server 230 adds the received user ID to a group ID corresponding to the device ID.

In step S1032, the group management server 230 notifies the image processing device 200 of a change completion.

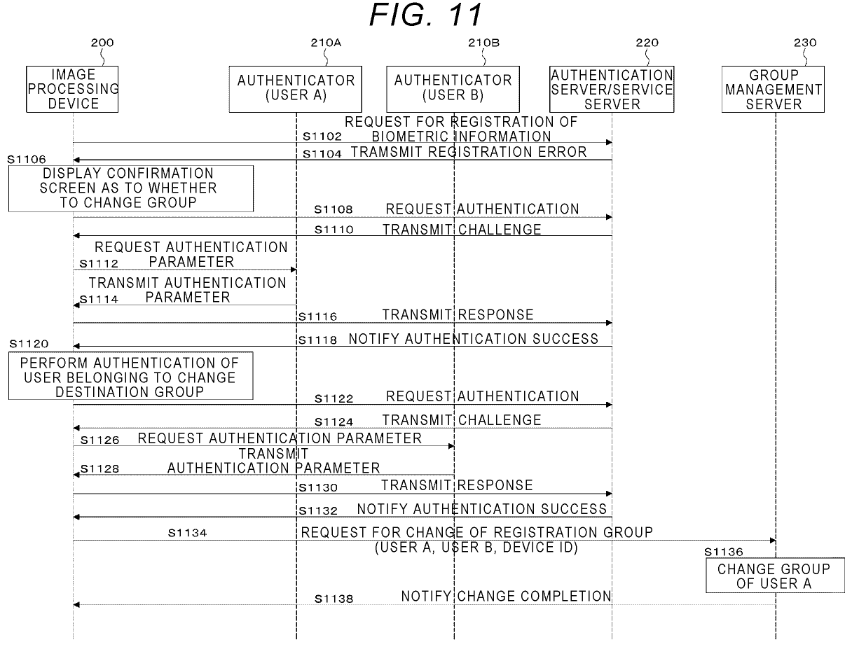

FIG. 11 is a flowchart of a process example according to the present exemplary embodiment.

This process example is directed to a case in which the group ID associated with the user 250A is to be replaced, for example, a case in which an organization to which the user 250A belongs is changed and a group to which the user 250A belongs is to be changed. It is assumed that, at present, the user 250A associated with a group 1 wants to replace a group to which he/she belongs with a group 2. It is also assumed that the user 250B belongs to the group 2.

In step S1102, the image processing device 200 requests the authentication server/service server 220 to register biometric information. Specifically, the user 250A starts a registration process using the image processing device 200 belonging to the group 2.

In step S1104, the authentication server/service server 220 transmits a registration error to the image processing device 200. The registration error indicates that the biometric information of the user 250A has already been registered. That is, since the biometric information of the user 250A has already been registered, the authentication server/service server 220 transmits the registration error.

In step S1106, the image processing device 200 displays a confirmation screen as to whether to change the group. That is, when receiving the registration error in step S1104, the image processing device 200 displays the confirmation screen as to whether to change an association between the user 250A and the group 1.

In step S1108, the image processing device 200 requests the authentication server/service server 220 to perform an authentication. That is, when the user 250A performs an operation of changing the group in step S1106, the image processing device 200 transmits an authentication request to the authentication server/service server 220.

Processes from step S1110 to step S1118 are equivalent to those from step S1004 to step S1012 illustrated in the example of FIG. 10.

In step S1110, the authentication server/service server 220 transmits a challenge to the image processing device 200.

In step S1112, the image processing device 200 requests the authenticator 210A for an authentication parameter.

In step S1114, the authenticator 210A transmits the authentication parameter to the image processing device 200.

In step S1116, the image processing device 200 transmits a response to the authentication server/service server 220.

In step S1118, the authentication server/service server 220 notifies the image processing device 200 of a successful authentication.

After step S1120, the image processing device 200 performs an authentication of the user 250B who belongs to a change destination group.

Processes from step S1122 to step S1132 are equivalent to those from step S1016 to step S1026 illustrated in the example of FIG. 10.

In step S1122, the image processing device 200 requests the authentication server/service server 220 to perform an authentication.

In step S1124, the authentication server/service server 220 transmits a challenge to the image processing device 200.

In step S1126, the image processing device 200 requests the authenticator 210B for an authentication parameter.

In step S1128, the authenticator 210B transmits the authentication parameter to the image processing device 200.

In step S1130, the image processing device 200 transmits a response to the authentication server/service server 220.

In step S1132, the authentication server/service server 220 notifies the image processing device 200 of a successful authentication.

In step S1134, the image processing device 200 requests the group management server 230 to change a registration group. At this time, the image processing device 200 transmits the user ID of the user 250A, the user ID of the user 250B, and the device ID of the image processing device 200.

In step S1136, the group management server 230 changes the group of the user 250A. That is, the user 250A is deleted from the group to which the user 250A belongs, and is registered in the group to which the user 250B belongs.

In step S1138, the group management server 230 notifies the image processing device 200 of the change completion.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The program described above may be provided by being stored in a recording medium, or the program may be provided by a communicator. In this case, for example, the above-described program may be regarded as a disclosure of a “computer-readable recording medium storing the program”.

The “computer-readable recording medium storing the program” refers to the recording medium that is readable in the computer in which the program is recorded, which is used for installation, execution of the program, distribution of the program, or the like.

The recording medium includes, for example, a digital versatile disc (DVD) such as “DVD-R, DVD-RW, DVD-RAM, or the like” that is a standard established by a DVD forum, or “DVD+R, DVD+RW, or the like” that is a standard established by the DVD+RW, a compact disc (CD) such as a read-only memory (CD-ROM), a CD recordable (CD-R), or a CD rewritable (CD-RW), a Blu-ray disc (registered trademark), a magneto-optical disc (MO), a flexible disc (FD), a magnetic tape, a hard disk, a read-only memory (ROM), an electrically erasable and rewritable read-only memory (EEPROM (registered trademark)), a flash memory, a random access memory (RAM), a secure digital (SD) memory card, or the like.

The whole or a part of the program may be recorded in the recording medium, stored, distributed, or the like. By communication, the program may be transmitted by using, for example, a transmission medium such as a wired network used for a local area network (LAN), a metropolitan area network (MAN), a wide area network (WAN), the Internet, an intranet, an extranet, a wireless communication network, and a combination thereof, or may be carried on a carrier wave.

Further, the program may be a part or the whole of another program, or may be recorded on the recording medium together with a separate program. In addition, the program may be divided into plural recording media and recorded. In addition, the program may be recorded in any form if the program can be restored by compression, encryption, or the like.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing device comprising:
a processor configured to:
when a first user performs an operation of joining a first group that is permitted to use a device or a service, cause an authentication server to perform a process of authentication with an authenticator, the process of the authentication using biometric authentication; and
when the authentication of the first user performed by the authentication server is successful, cause a group management server that manages the first group to perform a process of adding the first user to the first group.

2. The information processing device according to claim 1, wherein
the processor is configured to:
when the authentication performed by the authentication server is successful, cause the authentication server to perform the process of the authentication with an authenticator for a second user who has already joined the first group, the process of the authentication using the biometric authentication; and
when the authentication of the second user performed by the authentication server is successful, cause the group management server to perform the process of adding the first user to the first group.

3. The information processing device according to claim 2, wherein
the processor is configured to:
cause the group management server to perform the process of adding the first user to the first group under a condition that the second user is a predetermined user.

4. The information processing device according to claim 1, wherein
the processor is configured to:
when the first user performs an operation of joining a second group that is permitted to use a device or a service after the first user is registered in the first group, cause the authentication server to perform the process of the authentication with an authenticator, the process of the authentication using the biometric authentication;
when the authentication of the first user performed by the authentication server fails, cause the authentication server to perform the process of the authentication with an authenticator for a third user who has already joined the second group, the process of the authentication using the biometric authentication; and
when the authentication of the third user performed by the authentication server is successful, cause the group management server to perform a process of adding the first user to the second group.

5. The information processing device according to claim 4, wherein
the processor is configured to:
when receiving a notification indicating that the first user has already been registered in the authentication server, determine that the authentication of the first user performed by the authentication server has failed.

6. The information processing device according to claim 5, wherein
the processor is configured to:
cause the group management server to perform the process of adding the first user to the second group under a condition that the third user is a predetermined user.

7. A non-transitory computer readable medium storing a program that causes a computer to execute information processing, the information processing comprising:
when a first user performs an operation of joining a first group that is permitted to use a device or a service, causing an authentication server to perform a process of authentication with an authenticator, the process of the authentication using biometric authentication; and
when the authentication of the first user performed by the authentication server is successful, causing a group management server that manages the first group to perform a process of adding the first user to the first group.

8. An information processing device comprising:
first means for, when a first user performs an operation of joining a first group that is permitted to use a device or a service, causing an authentication server to perform a process of authentication with an authenticator, the process of the authentication using biometric authentication; and
second means for, when the authentication of the first user performed by the authentication server is successful, causing a group management server that manages the first group to perform a process of adding the first user to the first group.
